(19) United States
(12) Patent Application Publication
(10) Pub. No.: US 2007/0286121 A1
(43) Pub. Date: Dec. 13, 2007

(54) Systems and techniques for selective point-to-multipoint retransmission of multicast frames in a wireless network

(76) Inventors: Mikolaj Kolakowski, Reda (PL); Jacek Wysoczynski, Banino (PL)

Correspondence Address: KACVINSKY LLC;C/O INTELLEVATE, P.O. BOX 52050, MINNEAPOLIS, MN, 55402, US

(21) Appl. No.: 11/451,000

(22) Filed: Jun. 12, 2006

(51) Int. Cl. H04Q 7/00

(52) U.S. Cl. 370/329; 370/328

(57) ABSTRACT

Various embodiments for selective point-to multipoint retransmission of media content carried by multicast frames over a wireless communication link are described. In one embodiment, a device may be arranged to establish a main multicast channel and a multicast retransmission channel over a common wireless communication link. The device may communicate media content as one or more multicast frames over the main multicast channel and may communicate one or more requested multicast frames over the multicast retransmission channel in response to a retransmission request identifying one or more missing multicast frames lost during communication over the main multicast channel. Other embodiments are described and claimed.

### BACKGROUND

While wired communication links are almost loss-free, wireless communication links are inherently lossy. As such, a certain amount of information may be lost when transmitted and received over a wireless communication link. Left unattended, the lost information may have an adverse effect on the performance of a receiving device and associated applications. This is especially true in real-time multimedia applications supporting the streaming of audio and video content, as the lost information may result in service interruptions and a diminished user experience.

In some cases, a multimedia application may be used in a point-to-point or unicast communication environment in which a single source communicates with a single destination. In a unicast communication environment, media content lost due to dropped frames may be recoverable using conventional forward error correction (FEC) and/or retransmission techniques.

In a point-to-multipoint or multicast communication environment, media content may be broadcast from a single source to multiple destinations at the same time. While multicasting may conserve network bandwidth by avoiding the need to address and deliver media content individually to each destination, conventional FEC and/or retransmission techniques are not readily adapted to a multicast communication environment. As such, multicast traffic may suffer from lost information more than unicast traffic.

### BRIEF DESCRIPTION OF THE DRAWINGS

FIG. 1 illustrates one embodiment of a communications system.

FIG. 2 illustrates one embodiment of a wireless network.

FIG. 3 illustrates one embodiment of a communications system.

FIG. 4 illustrates one embodiment of a logic flow.

FIG. 5 illustrates one embodiment of a communication flow diagram.

FIG. 6 illustrates one embodiment of an article of manufacture.

### DETAILED DESCRIPTION

Various embodiments are directed to systems and techniques for selective point-to multipoint retransmission of media content carried by multicast frames over a wireless communication link to improve the reliability of a wireless multicast transmission of media content. In one embodiment, for example, a wireless communication link between a transmitter node and a receiver node may comprise a main multicast channel and a dedicated multicast retransmission channel. The retransmission channel may comprise a secondary multicast channel established in addition to the main multicast channel between the transmitter node and the receiver node. The main multicast channel and the multicast retransmission channel each may comprise a virtual channel utilizing dedicated resources or bandwidth of the physical wireless communication link. In some cases, the multicast retransmission channel may comprise underutilized bandwidth of the physical wireless communication link.

In various implementations, the transmitter node may be arranged to transmit a sequence of multicast frames to the receiver node over the main multicast channel. The receiver node may store the multicast frames received over the main multicast channel and send a retransmission request to the transmitter in the event that a missing or lost multicast frame is detected. In response to the retransmission request, the transmitter node may selectively retransmit the requested multicast frame to the receiver node over the dedicated multicast retransmission channel.

In various embodiments, the transmitter node may be arranged to buffer retransmission requests received from one or more receiver nodes and to retransmit a requested frame to multiple receiver nodes. The retransmission requests may be stored, for example, in a buffer that is internal and/or external to the transmitter node. In such embodiments, the retransmitted frame may be dropped by any receiver node that did not request the retransmitted frame or by any receiver that does not support the multicast retransmission mechanism.

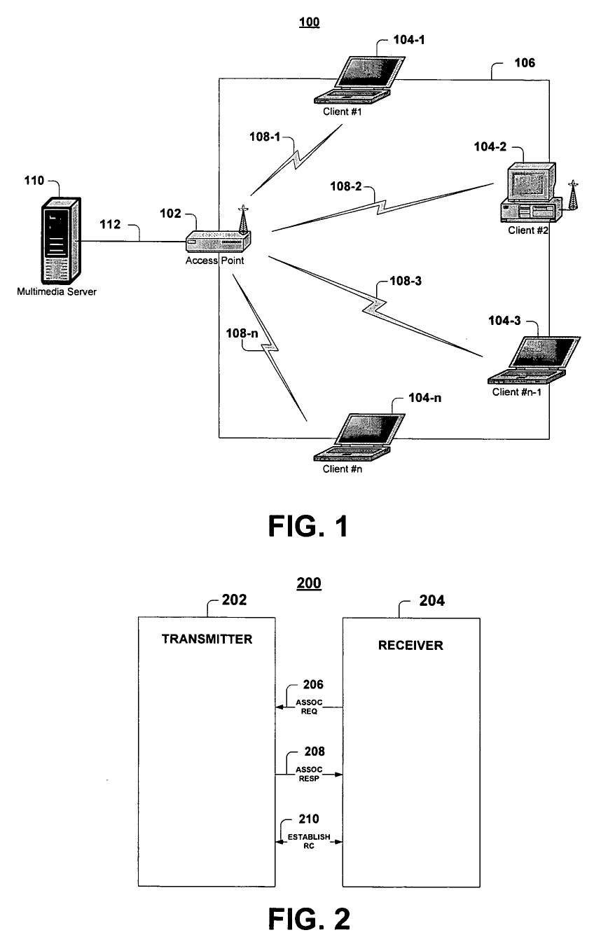

FIG. 1 illustrates a block diagram of one embodiment of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

The nodes of the communications system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks.

In various embodiments, the communications system 100 may comprise, or form part of a wired communications system, a wireless communications system, or a combination of both. For example, the communications system 100 may include one or more nodes arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The communications system 100 also may include one or more nodes arranged to communicate information over one or more types of wireless communication links. Examples of a wireless communication link may include, without limitation, a radio channel, infrared channel, radio-frequency (RF) channel, Wireless Fidelity (WiFi) channel, a portion of the RF spectrum, and/or one or more licensed or license-free frequency bands.

The communications system 100 may communicate information in accordance with one or more standards as promulgated by a standards organization, such as the International Telecommunications Union (ITU), the International Organization for Standardization (ISO), the International Electrotechnical Commission (IEC), the Institute of Electrical and Electronics Engineers (IEEE), the Internet Engineering Task Force (IETF), and so forth. In various embodiments, for example, the communications system 100 may communicate information according to one or more IEEE 802 standards including IEEE 802.3 standards for Ethernet based LANs such as the IEEE 802.3-2005 standard (IEEE 802.3-2005 IEEE Standard for Information technology-Telecommunications and information exchange between systems—Local and Metropolitan Area Networks—Specific requirements, Part 3: Carrier Sense Multiple Access with Collision Detection (CSMA/CD) Access Method and Physical Layer Specifications), its progeny, supplements thereto; IEEE 802.11 standards for WLANs such as the IEEE 802.11 standard (1999 Edition, Information Technology Telecommunications and Information Exchange Between Systems—Local and Metropolitan Area Networks—Specific Requirements, Part 11: WLAN Medium Access Control (MAC) and Physical (PHY) Layer Specifications), its progeny and supplements thereto (e.g., 802.11a, b, g/h, j, n, and variants); and/or IEEE 802.16 standards for WMANs including the IEEE 802.16 standard (IEEE Std 802.16-2001 for Local and Metropolitan area networks Part 16: Air Interface for Fixed Broadband Wireless Access Systems), its progeny and supplements thereto (e.g., 802.16-2004, 802.16.2-2004, 802.16e, 802.16f, and variants). The embodiments are not limited in this context.

The communications system 100 may communicate, manage, or process information in accordance with one or more protocols. A protocol may comprise a set of predefined rules or instructions for managing communication among nodes. In various embodiments, for example, the communications system 100 may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

The communications system 100 also may be arranged to operate in accordance with standards and/or protocols for media processing. Examples of media processing standards include, without limitation, the Digital Video Broadcasting Terrestrial (DVB-T) broadcasting standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, Motion Picture Experts Group (MPEG) standards (e.g., MPEG-1, MPEG-2, MPEG-4), and/or High performance radio Local Area Network (HiperLAN) standards. Examples of media processing protocols include, without limitation, Session Description Protocol (SDP), Real Time Streaming Protocol (RTSP), Real-time Transport Protocol (RTP), Synchronized Multimedia Integration Language (SMIL) protocol, and/or Internet Streaming Media Alliance (ISMA) protocol. The embodiments are not limited in this context.

As shown in FIG. 1, the communications system 100 may comprise a transmitter node 102 coupled to a plurality of receiver nodes 104-1-n, where n may represent any positive integer value. In various embodiments, the transmitter node 102 and the plurality of receiver nodes 104-1-n may be implemented as wireless devices. Examples of wireless devices may include, without limitation, a wireless access point (AP), a wireless client device, a wireless station (STA), a laptop computer, ultra-laptop computer, portable computer, personal computer (PC), notebook PC, handheld computer, personal digital assistant (PDA), cellular telephone, combination cellular telephone/PDA, smart phone, pager, messaging device, media player, digital music player, set-top box (STB), appliance, subscriber station, workstation, user terminal, mobile unit, and so forth. In such embodiments, the transmitter node 102 the receiver nodes 104-1-n may comprise one more wireless interfaces and/or components for wireless communication such as one or more transmitters, receivers, transceivers, chipsets, amplifiers, filters, control logic, network interface cards (NICs), antennas, and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, the transmitter node 102 the receiver nodes 104-1-n may comprise or form part of a wireless network 106. In one embodiment, for example, the wireless network 106 may comprise a wireless local area network (WLAN) such as a basic service set (BSS) and/or extended service set (ESS) wireless network. In such an embodiment, the wireless network 106 may communicate information in accordance with IEEE 802.11 and/or 802.16 standards for WLANs, implementing an associated protocol, and the transmitter node 102 may comprise an access point (AP) communicatively coupled to one or more receiver nodes 104-1-n comprising wireless clients or STAs.

Although some embodiments may be described with the wireless network 106 implemented as a WLAN for purposes of illustration, and not limitation, it can be appreciated that the embodiments are not limited in this context. For example, the wireless network 106 may comprise or be implemented as various types of wireless networks and associated protocols such as a Wireless Metropolitan Area Network (WMAN), a Wireless Personal Area Network (WPAN), a Wireless Wide Area Network (WWAN), a Worldwide Interoperability for Microwave Access (WiMAX) network, a Broadband Wireless Access (BWA) network, a radio network, a television network, a satellite network such as a direct broadcast satellite (DBS) network, and/or any other wireless communications network configured to operate in accordance with the described embodiments.

As shown in the embodiment of FIG. 1, the transmitter node 102 may be coupled to receiver nodes 104-1-n by wireless communication links 108-n. A particular wireless communication link (e.g., wireless communication link 108-1) may be arranged to establish one or more dedicated connections between the transmitter node 102 and a particular receiver node (e.g., receiver node 104-1). In various embodiments, a particular wireless communication link (e.g., wireless communication link 108-1) may include multiple virtual channels, with each of the virtual channels comprising a point-to-point logical connection from the transmitter node 102 to a particular receiver node (e.g., receiver node 104-1). In various implementations, multiple virtual channels may share a physical link, with each virtual channel comprising dedicated resources or bandwidth of the physical link.

In various embodiments, the transmitter node 102 and the receiver nodes 104-1-n may be arranged to establish and/or maintain the wireless communication links 108-1-n within the wireless network 106. In various implementations the transmitter node 102 and the receiver nodes 104-1-n may be arranged to communicate management information, such as different types of management frames, for establishing and maintaining the wireless communication links 108-1-n within the wireless network 106.

In some implementations, for example, the transmitter node 102 may be arranged to periodically send beacon frames to receiver nodes 104-1-n that are within the coverage area of the wireless network 106. The beacon frames may announce the presence of the transmitter node 102 and may include various types of information including, for example, synchronization information such as beacon rate or Delivery Traffic Indication Message (DTIM) period, identification information such as a service set identifier (SSID) of the wireless network 106, and/or other parameters regarding the transmitter node 102. The receiver nodes 104-1-n may be arranged to listen for and to use beacon frames as the basis for requesting association with the transmitter node 102.

To request an association, a receiver node such as receiver node 104-1 may send an association request frame to the transmitter node 102. The association request frame may provide information about the receiver node 104-1 to allow the transmitter node 102 to accept or reject the association. If the transmitter node 102 accepts the association, the transmitter node 102 may send an association response frame containing an acceptance to the receiver node 104-1. After the association is accepted, the receiver node 104-1 may establish a wireless communication link 108-1 to the transmitter node 102 that may be used for communicating with other devices within the wireless network 106, as well as with devices external to the wireless network 106.

In some implementations, the receiver nodes 104-1-n may be arranged to communicate probe request frames and probe response frames to obtain information from each other. For example, the receiver node 104-1 may send a probe request frame to the receiver node 104-n requesting the identity of an AP that is within range. In response to the probe request frame, the receiver node 104-n may send a probe response frame informing the receiver node 104-1 of the transmitter node 102.

In various embodiments, the wireless network 106 may support a multicast communication environment for distributing media content by multicasting. In one embodiment, for example, the wireless network 106 may be implemented as a WLAN that supports the broadcasting of media content by multicasting from a transmitter node 102-1-n implemented as an AP to a plurality of receiver nodes 104-1-n implemented as wireless clients or STAs. In such an embodiment, the AP may be arranged to broadcast a stream of media content by multicasting to a large group of wireless clients or STAs at the same time without the need to individually address and deliver many separate streams. As such, bandwidth of the wireless network 106 may be conserved.

The media content to be multicast may comprise, for example, various types of information such as image information, audio information, video information, audio/visual (A/V) information, and/or other data provided from the media source 108. In various embodiments, the information may be associated with one or more images, image files, image groups, pictures, digital photographs, music file, sound files, voice information, videos, video clips, video files, video sequences, video feeds, video streams, movies, broadcast programming, television signals, web pages, user interfaces, graphics, textual information (e.g., encryption keys, serial numbers, e-mail messages, text messages, instant messages, contact lists, telephone numbers, task lists, calendar entries, hyperlinks), numerical information, alphanumeric information, character symbols, and so forth. The information also may include command information, control information, routing information, processing information, system file information, system library information, software (e.g., operating system software, file system software, application software, game software), firmware, an application programming interface (API), a program, an applet, a subroutine, an instruction set, an instruction, computing code, logic, words, values, symbols, and so forth.

The transmitter node 102 may be arranged to receive media content to be multicast from a media source node 110. In various embodiments, the transmitter node 102 may be arranged to receive media content from the media source node 110 during or subsequent to an association phase. The media source node 110 generally may comprise any media source capable of delivering static or dynamic media content to the transmitter node 102. In one embodiment, for example, the media source node 110 may comprise a multimedia server arranged to provide broadcast or streaming media content to the transmitter node 102. In some implementations, the media source node 110 may form part of a media distribution system (DS) or broadcast system such as an over-the-air (OTA) broadcast system, a radio broadcast system, a television broadcast system, a satellite broadcast system, and so forth. In some implementations, the media source node 110 may be arranged to deliver media content pre-recorded and stored in various formats for use by a device such as a Digital Versatile Disk (DVD) device, a Video Home System (VHS) device, a digital VHS device, a digital camera, video camera, a portable media player, a gaming device, and so forth.

As shown in the embodiment of FIG. 1, for example, the transmitter node 102 may be coupled to the media source node 110 through a communication medium 112. The communication medium 112 generally may comprise any medium capable of carrying information signals such as a wired communication link, wireless communication link, or a combination of both, as desired for a given implementation. In various embodiments, the communication medium 112 may comprise a wired communication link implemented as a wired Ethernet and/or P2P connection, for example. In such embodiments, information may be communicated over the communication medium 112 in accordance with the IEEE 802.3, and the transmitter node 102 may receive media content from the media source node 110 substantially loss-free.

Although some embodiments may be described with the communication medium 112 implemented as a wired Ethernet and/or P2P connection for purposes of illustration, and not limitation, it can be appreciated that the embodiments are not limited in this context. For example, the communication medium 112 between the transmitter node 102 and the source node 110 may comprise various types of wired and/or wireless communication media and, in some cases, may traverse one or more networks between such devices.

The transmitter node 102 may be arranged to buffer media content and to parse or fragment the media content into multicast frames for multicast transmission to the receiver nodes 104-1-n. In some implementations, the transmitter node 102 may be arranged to parse or fragment the received media content as it is read into a buffer. In some embodiments, the media content provided to the transmitter node 102 may be delivered as one or more media frames. Each media frame may comprise a discrete data set having a fixed or varying length, and may be represented in terms of bits or bytes such as 16 kilobytes (kB), for example. It can be appreciated that the described embodiments are applicable to various types of communication content or formats, such as frames, packets, fragments, cells, units, and so forth.

In various embodiments, the transmitter node 102 may be arranged to create a sequence of multicast frames to be broadcast over one or more of the wireless communication links 108-1-n. Each multicast frame may comprise a discrete data set having fixed or varying lengths, and may be represented in terms of bits or bytes such as 1.5 kB according to the IEEE 802.11 standard, for example. Each multicast frame may contain a destination address comprising a group address corresponding to multiple intended recipients, such as receiver nodes 104-1-n. In some embodiments, the destination address may refer to all receiver nodes 104-1-n within the wireless network 106.

Although some embodiments may be described with the media content fragmented into multicast frames for purposes of illustration, and not limitation, it can be appreciated that the embodiments are not limited in this context. For example, the described embodiments are applicable to various types of communication content or formats, such as frames, packets, fragments, cells, units, and so forth.

The transmitter node 102 may be arranged to mark the relative position or order of each multicast frame within a broader sequence of the media content. In various embodiments, each multicast frame may be denoted by an identifier that allows explicit identification of each multicast frame such as, for example, a particular sequence number (e.g., SeqNo0, SeqNo1, SeqNo2) identifying the relative position or order of the multicast frame within the sequence. In some implementations, the transmitter node 102 may mark the multicast frames using a header or other mechanism when the multicast frames are read out of a buffer for multicast transmission.

In various embodiments, the transmitter node 102 may be arranged to generate a multicast traffic announcement (MTA) prior to transmitting one or more of the multicast frames to the receiver nodes 104-1-n. The MTA may comprise, for example, one or more of destination addresses (e.g., group address) and an identifier (e.g., sequence number) corresponding to each of the buffered multicast frames for each address. In some embodiments, the MTA may contain a copy of the MTA sent in a prior beacon, such as the most recent beacon, to enable retransmission to wireless STAs that may have missed the last beacon. For example, if a beacon with the MTA is missing, depending on the period of buffering, a wireless STA may work in legacy mode or receive a copy of the missing MTA in the next beacon and work with the copy. The MTA copies may be sent as long as the multicast frames announced in the MTA are available for retransmission. The embodiments are not limited in this context.

In various implementations, the MTA may be included as an information element within one or more beacons (e.g., beacon frames) issued by the transmitter node 102 to the receiver nodes 104-1-n within the coverage area of the wireless network 106. A receiver node that does not understand the MTA, such as a receiver node that does not support multicast retransmission, may ignore the MTA. In various embodiments, the beacons may include one or more of source information, destination information, and/or the identifiers (e.g., sequence numbers) of the multicast frames included within a current transmission window bounded, for example, by time, bandwidth, space, and so forth. In some implementations, the transmitter node 102 may issue one or more beacons prior to or concurrently with the reading of the multicast frames from the buffer.

In some embodiments, the transmitter node 102 may be arranged to initiate a buffer validity time after sending a beacon. In one embodiment, for example, the transmitter node 102 may initialize the buffer validity timer to track the aging of the media content (e.g., multicast frames) in the buffer. The validity timer may be set to a value of two beacon periods (e.g., DTIM periods) by default, for example. Once the timer expires, the transmitter node 102 may flush or purge the buffer to free storage space in the buffer for new media content. The embodiments are not limited in this context.

Commensurate with or subsequent to the transmission of a beacon, the transmitter node 102 may initiate a multicast transmission of media frames to one or more of the receiver nodes 104-1-n over one or more of the wireless communication links 108-1-n. In various embodiments, one or more of the wireless communication links 108-1-n may comprise a main multicast channel and a dedicated multicast retransmission channel. The main multicast channel and the multicast retransmission channel may be established during an association phase, for example.

The multicast retransmission channel may comprise a secondary multicast channel established in addition to the main multicast channel over a common physical link. As such, simultaneous traffic for both the main multicast channel as well as the secondary multicast channel may be supported by a common physical link. For example, a particular wireless communication link (e.g., wireless communication link 108-1) may include multiple virtual channels comprising point-to-point logical paths between the transmitter node 102 and the particular receiver node (e.g., receiver node 104-1). The main multicast channel and the multicast retransmission channel each may comprise a virtual channel utilizing dedicated resources or bandwidth of a common physical wireless communication link.

In various embodiments, the multicast retransmission channel may comprise underutilized bandwidth of the physical wireless communication link. For example, the distribution of media content typically may consume about one megabyte per second (1 Mb/s), while a wireless communication link in a WLAN typically may provide a physical bandwidth of between 2 and 54 Mb/s. Accordingly, the multicast retransmission channel may make effective use of underutilized bandwidth of a physical wireless communication link to improve the reliability of a multicast transmission.

The transmitter node 102 may be arranged to transmit a sequence of multicast frames to one or more of the receiver nodes 104-1-n using the main multicast channel for each of the receiver nodes 104-1-n. In various embodiments, multicast frames are transmitted sequentially over a multicast channel on a frame-by-frame basis. Each multicast frame may comprise a fragmented size of 1.5 kB, for example. In some implementations, the multicast frames may be transmitted within a DTIM period after sending a DTIM beacon.

Each of the receiver nodes 104-1-n may be arranged to store and buffer multicast frames received over the main multicast channel and to send a retransmission request to the transmitter node 102 in the event that a missing or lost multicast frame is detected. In various embodiments, each of the receiver nodes 104-1-n may be arranged to detect a missing or lost multicast frame by receiving and decoding beacons received from the transmitter node 102 to recover the identifiers (e.g., sequence numbers) of the multicast frames sent by the transmitter node 102.

Upon receiving one or more beacons, each of the receiver nodes 104-1-n may be arranged buffer at least a subset of information received in the beacons. In various implementations, each of the receiver nodes 104-1-n may store MTAs received in beacons and then check the status of the MTAs to determine whether the multicast frames announced in the MTAs have been received. Stored MTAs may be removed after all announced multicast frames have been received and/or after retransmission of a lost or missing multicast frame was requested, but no response was received during a transmission window such as a DTIM period.

The receiver nodes 104-1-n may monitor the buffered multicast frames and compare the identifiers (e.g., sequence numbers) of the received multicast frames against the identifiers (e.g., sequence numbers) announced in the received beacons. If a particular receiver node does not confirm receipt of one or more multicast frames, the receiver node may issue a retransmission request to the transmitter node 102 requesting the lost or missing multicast frames. In various implementations, a multicast frame may be considered lost or missing if not received before an out-of-order multicast frame is received, a DTIM period passes, a subsequent beacon is received, a particular media application requires such frame, and/or the expiration of a transmission window.

The retransmission request may comprise, for example, a listing of one or more identifiers (e.g., sequence numbers) corresponding to the missing or lost multicast frames as well as the addresses of the requesting and transmitting devices. In various embodiments, the retransmission request may comprise a MAC layer message communicated to the transmitter node 102. In various implementations, the transmitter node 102 may begin to gather retransmission requests after sending a new beacon.

The receiver nodes 104-1-n that request retransmission may stay awake so that the transmitter node 102 does not need to wait for a transmission window (e.g., DTIM period) to resend missing or lost multicast frames. In some embodiments, the receiver nodes 104-1-n may be arranged to request retransmission only once. In such embodiments, if the retransmission fails, the multicast frame is assumed lost.

In response to receiving a retransmission request, the transmitter node 102 may determine whether the requested multicast frames are buffered. If the requested multicast frames are available for retransmission, the transmitter node 102 may retrieve the requested multicast frame from the buffer for retransmission. In various embodiments, the transmitter node 102 may buffer the multicast frames with a window-like mechanism implemented like a circular buffer. For example, after a validity timer expires, the window moves forward and the oldest frames are flushed or purged. As such, requested multicast frames may not be available for retransmission, for example, if the requested multicast frames have be removed from the buffer.

In various implementations, the transmitter node 102 may be arranged to buffer retransmission requests received from one or more of the receiver nodes 104-1-n and to retransmit a requested frame to multiple receiver nodes, such as receiver nodes 104-1-n. The retransmission requests may be stored, for example, in a buffer that is internal and/or external to the transmitter node 102. In such embodiments, the retransmitted frame may be dropped by any receiver node that did not request the retransmitted frame or by any receiver node that does not support the multicast retransmission mechanism. When received by the receiver node that requested the retransmitted frame, the missing or lost frame may be properly ordered relative to other received frames.

In various embodiments, the transmitter node 102 may be arranged to perform selective point-to multipoint retransmission of media content carried by multicast frames over one or more of the wireless communication links 108-1-n. For example, in response to the retransmission request, the transmitter node 102 may selectively retransmit the requested multicast frame to one or more of the receiver nodes 104-1-n over the corresponding dedicated multicast retransmission channels. Each retransmission channel may comprise a secondary multicast channel established in addition to a main multicast channel between the transmitter node 102 and a particular receiver node. In various implementations, the main multicast channel and the retransmission channel may comprise separate and distinct virtual channels.

In various embodiments, the multicast retransmission channel may be implemented at the MAC layer of the communication protocol stack within a transceiver and/or wireless communication chipset of a wireless device. In such embodiments, the multicast retransmission channel may be assigned a unique multicast IP address in accordance with rules for MAC multicast addresses creation as defined by one or more IEEE communications standards. The IP address of the multicast retransmission channel may be assigned by an administrator, for example. Accordingly, retransmission traffic may be differentiated from other multicast streams, and wireless clients or STAs that do not support the multicast retransmission channel will drop retransmitted multicast frames sent to the IP address of the multicast retransmission channel.

In one embodiment, for example, the contents of a retransmitted multicast frame may comprise the following parameters:

802.11 ADDR1 (receiver)=MCAST RC ADDR.

802.11 ADDR2 (transmitter)=AP MAC ADDR.

802.11 ADDR3=BSSID.

SeqNo=SeqNo of the missing frame.

Payload=original multicast frame payload.

### If encryption was enabled for the payload of an original multicast frame, identical encryption may be employed for the payload in the retransmitted multicast frame.

In general, performing retransmission on a higher layer of an application may cause greater latency and bandwidth utilization. By implementing the multicast retransmission channel at the MAC layer of the communication protocol stack in the transmitter node 102 and/or the receiver nodes 104-1-n, the retransmission capability is offloaded from higher layers, such as an application layer. When implemented at the MAC layer, the multicast retransmission channel may make use of previously underutilized bandwidth to support real-time multimedia broadcast traffic in support of legacy multimedia processing applications. Accordingly, the quality and reliability of such multimedia processing applications may be improved without a commensurate, costly upgrade of such applications.

In various implementations, the multicast retransmission channel may be arranged to supplement the main multicast communication channel with retransmitted media content carried by multicast frames that otherwise would be lost during transmission over the main multicast channel and/or during receive processing at a receiver node. Rather than retransmitting the content over the main multicast channel, perhaps impairing the perceived quality of that communication channel, the transmitter node 102 coordinates the selective retransmission of lost or missing multicast frames over the established dedicated retransmission channel. The dedicated retransmission channel thus provide support for an alternate, reliable means of retransmitting media content that would otherwise be lost to, or unrecoverable from a lossy wireless multicast communication channel. Accordingly, the multicast retransmission channel may significantly improve the user experience associated with wireless communication applications, such as real-time multimedia applications supporting the streaming of audio and video content.

FIG. 2 illustrates a block diagram of one embodiment of a wireless network 200. For ease of illustration, and not limitation, the wireless network 200 depicts a limited number of nodes by way of example. It can be appreciated that more nodes may be employed for a given implementation.

As shown, the wireless network 200 may comprise a transmitter node 202 coupled to a receiver node 204. In various embodiments, the wireless communications system 200 may comprise or be implemented by one or more elements of the communications system 100 of FIG. 1, such as wireless network 100, transmitter node 102, and receiver nodes 104-1-n. The embodiments are not limited in this context.

In one embodiment, for example, the transmitter node 202 and the receiver node 204 may be implemented as wireless devices, and the wireless network 200 may be implemented as a WLAN. In such an embodiment, the wireless network 200 may communicate information in accordance with the IEEE 802.11 and/or 802.16 standards for WLANs, implementing an associated protocol, and the transmitter node 202 may comprise an AP communicatively coupled to the receiver node 204 comprising a wireless client or STA. In various implementations, the wireless network 200 may support a multicast communication environment for distributing media content by multicasting from the transmitter node 202 to the receiver node 204. The embodiments are not limited in this context.

In one embodiment, for example, the transmitter node 202 and the receiver node 204 each may include the capability to establish a dedicated multicast retransmission channel. The retransmission channel may comprise a secondary multicast channel established in addition to a main multicast channel between the transmitter node 202 and the receiver node 204. As such a particular physical wireless communication link between the transmitter node 202 and the receiver node 204 may support both a multicast communication channel as well as the secondary multicast channel. For example, the main multicast channel and the multicast retransmission channel each may comprise a virtual channel utilizing dedicated resources or bandwidth of a common physical wireless communication link.

In various embodiments, the multicast retransmission channel may be implemented at the MAC layer of the communication protocol stack within a transceiver and/or wireless communication chipset of a wireless device. In such embodiments, the multicast retransmission channel may be assigned a unique multicast IP address in accordance with rules for MAC multicast addresses creation as defined by one or more IEEE communications standards. The IP address of the multicast retransmission channel may be assigned by an administrator, for example. Accordingly, retransmission traffic may be differentiated from other multicast streams, and wireless clients or STAs that do not support the multicast retransmission channel will drop retransmitted multicast frames sent to the IP address of the multicast retransmission channel.

In some embodiments, the transmitter node 202 and the receiver node 204 may agree during an association phase to establish a dedicated multicast retransmission channel. In various implementations, the transmitter node 202 and the receiver node 204 may announce the capability to establish a dedicated multicast retransmission channel by communicating management information such as beacons, association requests, association responses, probe requests, and/or probe responses within the wireless network 200.

During the association phase, the receiver node 204 may issue an association request 206 to the transmitter node 202. In various embodiments, the receiver node 204 may send the association request 206 in response to receiving a beacon from the transmitter node 202. The beacon from the transmitter node 202 may announce the presence of the transmitter node 202 as well as the capability of the transmitter node 202 to establish a dedicated multicast retransmission channel. The receiver node 204 may be arranged to listen for and to use beacon frames as the basis for requesting association with the transmitter node 202.

Association may occur after a beacon, but in many cases there may be an exchange of additional management information, such as an exchange of probe requests and probe responses during preparation of an association. In various embodiments, for example, additional frames (e.g., probe request frames, probe response frames) containing information about the capability of the transmitter node 202 (e.g., AP) may be exchanged during the association phase. For example, a beacon frame may announce the presence of the wireless network 200 and in most cases may contain a network identifier such as an SSID to facilitate scanning operations. In some cases, however, the beacon might not contain an SSID, and the transmitter node 202 might not respond to a broadcast probe request, as a part of increasing network security, for example. In such cases, a receiver node 204 that wants to associate must know the name of a network and need to exchange probe frames asking about a specific SSID.

The association request 206 may provide information about the receiver node 204 to allow the transmitter node 202 to accept or reject the association. In various embodiments, the association request 206 may comprise an additional or special information element (IE) containing information about the IP address of the multicast communication channel.

If the transmitter node 202 accepts the association, the transmitter node 202 may send an association response frame containing an acceptance to the receiver node 204. In various embodiments, the association request 208 may comprise information supporting retransmission. After the association is accepted, the transmitter node 202 and the receiver node 204 may establish a multicast retransmission channel 210.

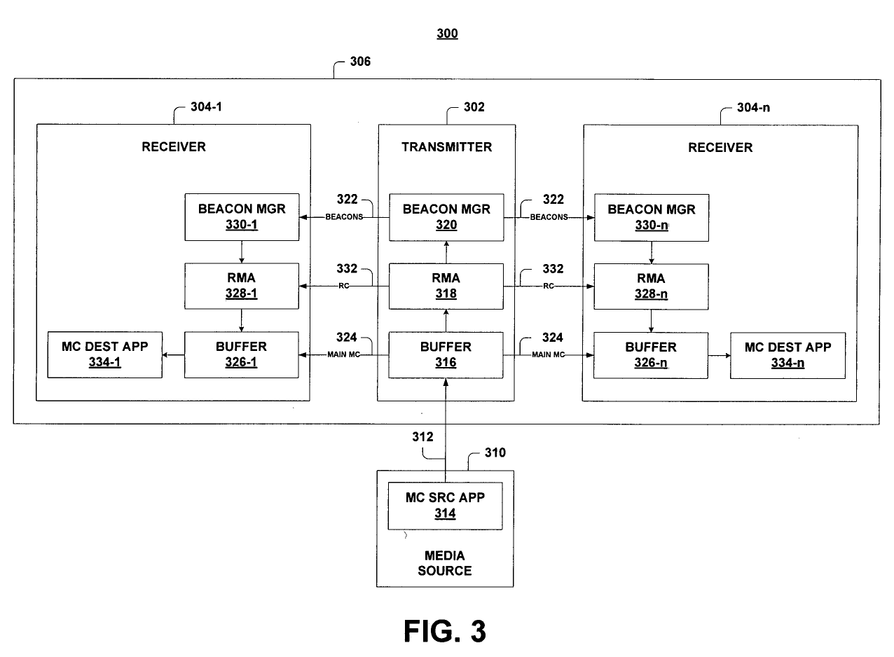

FIG. 3 illustrates a block diagram of one embodiment of a communications system 300. For ease of illustration, and not limitation, the communications system 300 depicts a limited number of nodes by way of example. It can be appreciated that more nodes may be employed for a given implementation. In various embodiments, the communications system 300 may comprise or be implemented by one or more elements of the communications system 100 of FIG. 1 and/or the wireless network 200 of FIG. 2. The embodiments are not limited in this context.

As shown in FIG. 3, the communications system 300 may comprise a transmitter node 302 coupled to a plurality of receiver nodes 304-1-n, where n may represent any positive integer value. In various embodiments, the transmitter node 302 and the plurality of receiver nodes 304-1-n may be implemented as wireless devices and may form part of a wireless network 306 such a WLAN. In such embodiments, the wireless network 306 may communicate information in accordance with the IEEE 802.11 and/or 802.16 standards for WLANs, implementing an associated protocol, and the transmitter node 302 may comprise an access point (AP) communicatively coupled to one or more receiver nodes 304-1-n comprising wireless clients or STAs. The embodiments are not limited in this context.

In various embodiments, the wireless network 306 may support a multicast communication environment for distributing media content by multicasting. In one embodiment, for example, the wireless network 306 may be implemented as a WLAN that supports the broadcasting of media content by multicasting from a transmitter node 302 implemented as an AP to a plurality of receiver nodes 304-1-n implemented as wireless clients or STAs.

In various embodiments, the transmitter node 302 may be arranged to receive media content to be multicast from a media source node 310 through a communication medium 312. In various embodiments, the communication medium 312 may comprise a wired communication link implemented as a wired Ethernet and/or P2P connection, for example. In such embodiments, information may be communicated over the communication medium 312 in accordance with the IEEE 802.3, and the transmitter node 302 may receive media content from the media source node 310 substantially loss-free. The embodiments are not limited in this context.

As shown in FIG. 3, the nodes of the communications system 300 may be illustrated and described as comprising several separate functional elements, such as modules and/or blocks. In various implementations, the modules and/or blocks may be connected by one or more communications media such as, for example, wired communication media, wireless communication media, or a combination of both, as desired for a given implementation. Although various embodiments may be described in terms of modules and/or blocks to facilitate description, it is to be appreciated that such modules and/or blocks may be implemented by one or more hardware components, software components, and/or combination thereof.

As shown, the media source node 310 may comprise a multicast source (MC SRC) block 314. In various embodiments, the multicast MC SRC block 314 may comprise one or more applications to provide media content to requesting devices, such as the transmitter node 302 or the receiver nodes 304-1-n of the wireless network 306. In various embodiments, the MC SRC block 314 may be arranged to provide media content to the transmitter node 302 as one or more media frames (e.g., 16 kB media frames).

In various embodiments, the transmitter node 302 may comprise a buffer block 316 implemented by one or more buffers. The buffer block 316 may comprise, for example, a one or more storage areas within the transmitter node 302 configured to buffer media content to be multicast to the receiver nodes 304-1-n. As shown, in FIG. 1, for example, the buffer block 316 may be coupled to the media source node 302 and receive media content to be multicast through the communication medium 312 (e.g., wired Ethernet connection).

As depicted in the embodiment of FIG. 1, the transmitter node 302 may comprise a reliable multicast agent (RMA) module 318. The RMA module 318 may be implemented, for example, by hardware, software, and/or firmware in the transmitter node 302. The RMA module 318 may comprise, for example, instructions and/or code to be executed by the transmitter node 302. In various embodiments, the RMA module 318 may be implemented by the MAC layer of a wireless interface and/or component in the transmitter node 302. In such embodiments, the RMA module 318 may be implemented as a feature in the MAC layer of the communication protocol stack within a transceiver and/or wireless communication chipset of a wireless device. The embodiments are not limited in this context.

In various implementations, the RMA module 318 may be arranged to work in conjunction with a beacon manager module 320 within the transmitter node 302. In various embodiments, the RMA module 318 and the beacon manager module 320 may manage and monitor the quality of the multicast transmissions. The beacon manager module 320 may comprise, for example, instructions and/or code to be executed by the transmitter node 302. In some implementations, the beacon manager module 320 may function in response to and/or under the control of the RMA module 318. Although depicted as separate modules in FIG. 3, in some embodiments, the beacon manager module 320 may be integrated within the RMA module 318. The embodiments are not limited in this context.

In various embodiments, the beacon manager module 320 may be arranged to issue one or more beacons 322 to devices within the coverage area of the wireless network 306. Referring to FIG. 3, for example, the beacon manager module 320 of the transmitter node 302 may issue beacons 322 to the plurality of receiver nodes 304-1-n within the wireless network 306. Prior to an association phase, for example, the beacon manager module 320 may issue beacons 322 that comprise an information element denoting that the transmitter node 302 supports RMA multicast transmission and/or retransmission capability.

The RMA module 318 may be arranged to perform one or more management functions associated with the multicast distribution of media content. For example, the RMA module 318 may be arranged to manage the multicast communication of media content from the transmitter node 302 to one or more of the receiver nodes 304-1-n. In various implementations, the RMA module 318 may be arranged to buffer media content and to parse or fragment the media content into multicast frames for multicast transmission. In some implementations, the RMA module 318 may be arranged to parse or fragment the received media content as it is read into the buffer block 316.

In various embodiments, the RMA module 318 may be arranged to create a sequence of multicast frames. Each multicast frame (e.g., 1.5 kB multicast frame) may contain a destination address comprising a group address corresponding to multiple intended recipients, such as receiver nodes 304-1-n. In some embodiments, the destination address may refer to all receiver nodes 304-1-n within the wireless network 306.

The RMA module 318 may be arranged to mark the relative position or order of each multicast frame. In various embodiments, each multicast frame may be denoted by an identifier that allows explicit identification of each multicast frame such as, for example, a particular sequence number (e.g., SeqNo0, SeqNo1, SeqNo2) identifying the relative position or order of the multicast frame within the sequence. In some implementations, the RMA module 318 may mark the multicast frames using a header or other mechanism when the multicast frames are read out of the buffer block 316 for multicast transmission.

In various embodiments, the RMA module 318 may be arranged to generate a MTA prior to transmitting one or more of the multicast frames. The MTA may comprise, for example, one or more of destination addresses (e.g., group address) and an identifier (e.g., sequence number) corresponding to each of the buffered multicast frames for each address. In some embodiments, the MTA may contain a copy of the MTA sent in a prior beacon, such as the most recent beacon, to enable retransmission to devices that may have missed the last beacon. The embodiments are not limited in this context.

In various implementations, the RMA module 318 may communicate the MTA to the beacon manager module 320. In response, the beacon manager module 320 may include the MTA as an information element within one or more beacons 322 to be transmitted to the plurality of receiver nodes 304-1-n. A receiver node that does not understand the MTA, such as a receiver node that does not support multicast retransmission, may ignore the MTA. In various embodiments, the beacons 322 may include one or more of source information, destination information, and/or the identifiers (e.g., sequence numbers) of the multicast frames to be delivered within a current transmission window (e.g., DTIM period). In some implementations, the beacon manager module 320 may issue one or more beacons 322 prior to or concurrently with the reading of the multicast frames from the buffer block 316.

In some embodiments, after one or more beacons 322 have been sent, the RMA module 318 may initiate a buffer validity timer. In one embodiment, for example, the RMA module 318 may initialize the buffer validity timer to track the aging of the media content (e.g., multicast frames) in the buffer block 316. The validity timer may be set to a value of two beacon periods (e.g., DTIM periods) by default, for example. Once the timer expires, the buffer block 316 may be purged or flushed to free storage space for new media content. The embodiments are not limited in this context.

Commensurate with or subsequent to the transmission of one or more beacons 322, the RMA module 318 may initiate a multicast transmission of media frames to one or more of the receiver nodes 304-1-n over a corresponding main multicast channel 324. In various embodiments, the RMA module 318 may be arranged to manage the transmission of a sequence of multicast frames over a main multicast channel 324. In various embodiments, multicast frames may be read from the buffer block 316 and transmitted sequentially over a multicast channel 324 on a frame-by-frame basis. Each multicast frame may comprise a fragmented size of 1.5 kB, for example. In some implementations, the multicast frames may be transmitted within a DTIM period after sending a DTIM beacon.

Each of the receiver nodes 304-1-n may be arranged to store and buffer multicast frames received over a main multicast channel 324. As shown in the embodiment of FIG. 3, each of the receiver nodes 304-1-n may comprise corresponding buffer blocks 326-1-n, RMA modules 328-1-n, and beacon manager modules 330-1-n, logically coupled as depicted. In various embodiments, the buffer blocks 326-1-n, RMA modules 328-1-n, and beacon manager modules 330-1-n of the receiver nodes 304-1-n may perform operations complementary to operations performed by the buffer block 316, RMA module 318, and the beacon manager module 320 of the transmitter node 302. In some embodiments, for example, the RMA module 318 and each of the RMA modules 328-1-n may be implemented in a transmitter-receiver pair to perform multicast retransmission.

In various embodiments, each of the buffer blocks 326-1-n may be implemented by one or more buffers comprising one or more storage areas configured to buffer multicast media content received over a main multicast channel 324. Each of the corresponding RMA modules 328-1-n may be arranged to monitor the multicast frames in the buffer blocks 326-1-n and to compare the identifiers (e.g., sequence numbers) of the received multicast frames against the identifiers (e.g., sequence numbers) identified in the received beacons 322 to identify missing or lost multicast frames.

In some embodiments, the RMA modules 328-1-n may monitor sequence numbers as multicast media frames are written into the corresponding buffer block 326-1-n. In other embodiments, the RMA modules 328-1-n may interrogate the corresponding buffer blocks 326-1-n to identify the sequence numbers of stored multicast frames and/or or may monitor sequence numbers as multicast frames are read out of the corresponding buffer blocks 326-1-n. The embodiments are not limited in this context.

Each of the receiver nodes 304-1-n may comprise corresponding beacon manager modules 330-1-n arranged to receive and decode beacons 322 to recover one or more of source information, destination information and/or identifiers (e.g., sequence numbers) of multicast frames sent over a main multicast channel 324. The beacon manager modules 330-1-n may provide at least a subset of the recovered information to corresponding RMA modules 328-1-n. For example, the RMA modules 328-1-n may be provided with MTAs announcing the sequence numbers of multicast media frames that were sent by the transmitting node 302 device and should be present within corresponding buffer blocks 326-1-n. The MTAs may be stored until all announced multicast frames have been received and/or until retransmission of a lost or missing multicast frame was requested, but no response was received during a transmission window (e.g., DTIM period). The MTAs may be ignored by any receiver node that does not understand the MTA, such as a receiver node that does not support multicast retransmission.

Each of the RMA modules 328-1-n may be arranged to issue a retransmission request to the RMA module 318 of the transmitter node 302 in the event that a missing or lost multicast frame is detected. In various implementations, a multicast frame may be considered lost or missing if not received before an out-of-order multicast frame is received, a DTIM interval passes, a subsequent beacon is received, a particular media application requires such frame, and/or the expiration of a transmission window bounded by time, space, bandwidth, and so forth. The retransmission request may comprise, for example, a listing of one or more identifiers (e.g., sequence numbers) corresponding to the missing or lost multicast frames as well as the address for the requesting and transmitting devices.

In response to the retransmission request, the RMA module 318 may determine whether the requested multicast frames are stored in the buffer block 316. If the requested multicast frames are available for retransmission, the transmitter node 302 may retrieve the requested multicast frame from the buffer block 316 for retransmission. In some cases, requested multicast frames may have been purged from the buffer and are not available for retransmission.

In various implementations, the RMA module 318 may be arranged to buffer retransmission requests received from one or more of the receiver nodes 304-1-n and to retransmit a requested frame to multiple receiver nodes, such as receiver nodes 304-1-n. In such embodiments, the retransmitted frame may be dropped by any receiver node that did not request the retransmitted frame or by any receiver node that does not support the multicast retransmission mechanism.

In various embodiments, the RMA module 318 may be arranged to perform selective point-to multipoint retransmission of media content. For example, in response to the retransmission request, the RMA module 318 may selectively retransmit the requested multicast frame to one or more of the receiver nodes 304-1-n over a corresponding dedicated multicast retransmission channel 332. Each multicast retransmission channel 332 may comprise a secondary multicast channel established in addition to a main multicast channel 324 between the transmitter node 302 and one of the receiver nodes 304-1-n.

The main multicast channel 324 and the retransmission channel 332 each may comprise separate and distinct virtual channels. In various embodiments, the main multicast channel 324 and the multicast retransmission channel 332 each may comprise a virtual channel utilizing dedicated resources or bandwidth of a common physical wireless communication link. As such, both the main multicast communication channel 324 as well as the multicast retransmission channel 332 may be supported by a particular physical wireless communication link between the transmitter node 302 and one of the receiver nodes 304-1-n. In various embodiments, the multicast retransmission channel 332 may comprise underutilized bandwidth of the physical wireless communication link.

As shown in FIG. 3, each of the receiver nodes 304-1-n may comprise corresponding multicast destination (MC DEST) blocks 334-1-n. Each of the MC DEST blocks 334-1-n may comprise, for example, one or more applications to receive media content from the media source node 310. In various embodiments, each of the MC DEST blocks 334-1-n may comprise one or more real-time multimedia applications (e.g., media player) for rendering streaming audio and/or video content to an end-user of device. The embodiments are not limited in this context.

Operations for various embodiments may be further described with reference to the following figures and accompanying examples. Some of the figures may include a logic flow. It can be appreciated that an illustrated logic flow merely provides one example of how the described functionality may be implemented. Further, a given logic flow does not necessarily have to be executed in the order presented unless otherwise indicated. In addition, a logic flow may be implemented by a hardware element, a software element executed by a processor, or any combination thereof. The embodiments are not limited in this context.

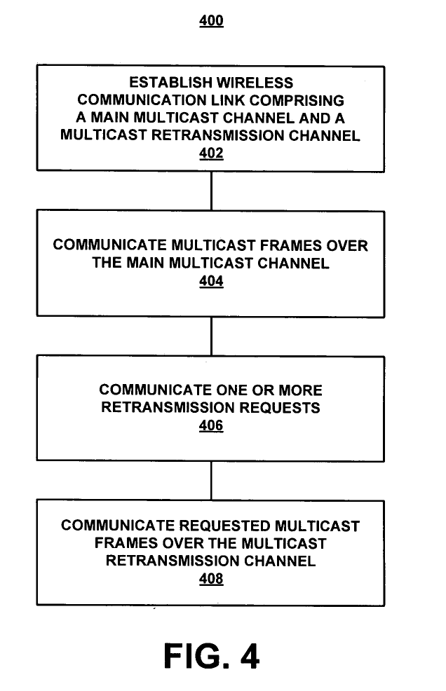

FIG. 4 illustrates one embodiment of a logic flow 400 for retransmission of media content carried by multicast frames. In various embodiments, the logic flow 400 may be performed by various systems, nodes, and/or modules and may be implemented as hardware, software, and/or any combination thereof, as desired for a given set of design parameters or performance constraints. For example, the logic flow 400 may be implemented by a logic device (e.g., transmitter node, receiver node) and/or logic (e.g., RMA logic) comprising instructions, data, and/or code to be executed by a logic device. For purposes of illustration, and not limitation, the logic flow 400 is described with reference to FIG. 1. The embodiments are not limited in this context.

The logic flow 400 may comprise establishing one or more wireless communication links comprising a main multicast channel and a dedicated multicast retransmission channel (block 402). In various embodiments, the wireless communication links may be established between a transmitter node 102 and one or more receiver nodes 104-1-n within a wireless network 106 (e.g., WLAN) that supports a multicast communication environment for distributing media content by multicasting. The main multicast channel and the multicast retransmission channel may be established during an association phase, and simultaneous traffic for both the main multicast channel as well as the multicast retransmission channel may be supported by a common wireless communication link.

The main multicast channel and the retransmission multicast channel each may comprise a virtual channel utilizing dedicated resources or bandwidth of a common physical wireless communication link. The multicast retransmission channel may comprise a secondary multicast channel established in addition to the main multicast channel to supplement the main multicast communication channel with retransmitted media content carried by multicast frames lost during transmission over the main multicast channel. In various embodiments, the multicast retransmission channel may be implemented at the MAC layer of the communication protocol stack of a wireless device.

The logic flow 400 may comprise communicating multicast frames over the main multicast channel (block 404). In various embodiments, the multicast frames may be transmitted over the main multicast channel by a transmitter node 102 and may be received over the main multicast channel by one or more receiver nodes 104-1-n. In various implementations, media content may be buffered and parsed or fragmented into a sequence of multicast frames for multicast transmission over the main multicast channel. Each multicast frame may be denoted by an identifier that allows explicit identification of each multicast frame such as, for example, a particular sequence number (e.g., SeqNo0, SeqNo1, SeqNo2) identifying the relative position or order of the multicast frame within the sequence.

In various embodiments, beacons may be issued by the transmitter node 102 to one or more receiver nodes 104-1-n prior to transmission of the multicast frames. The beacons may include a MTA comprising a sequence number corresponding to each of the multicast frames to be transmitted over the main multicast channel.

The logic flow 400 may comprise communicating one or more retransmission requests (block 406). In various embodiments, retransmission requests may be sent to a transmitter node 102 by one or more receiver nodes 104-1-n. Each of the receiver nodes 104-1-n may be arranged to store and buffer multicast frames received over the main multicast channel and to issue a retransmission request when a lost or missing multicast frame is detected. In various implementations, a lost or missing multicast frame may be detected by receiving and decoding beacons to recover the identifiers (e.g., sequence numbers) of transmitted multicast frames. The sequence numbers of buffered multicast frames may be compared against the sequence numbers identified in the received beacons to confirm whether all multicast frames have been received.

In various embodiments, the retransmission request may comprise a listing of one or more identifiers (e.g., sequence numbers) corresponding to the missing or lost multicast frames as well as the addresses of the requesting and transmitting devices. In some implementations, the retransmission request may comprise a MAC layer message communicated to the transmitter node 102.

The logic flow 400 may comprise communicating requested multicast frames over the multicast retransmission channel (block 408). In various embodiments, requested multicast frames may be transmitted over the multicast retransmission channel by a transmitter node 102 and may be received over a multicast retransmission channel by one or more receiver nodes 104-1-n. In various implementations, the transmitter node 102 may selectively retransmit requested multicast frames to one or more of the receiver nodes 104-1-n over a corresponding multicast retransmission channel. The requested multicast frames may be transmitted in response to receiving a retransmission request. In various implementations, the transmitter node 102 may determine whether the requested multicast frames are buffered and may retrieve the requested multicast frame from the buffer for retransmission.

In various embodiments, retransmission requests received from one or more of the receiver nodes 104-1-n may be buffered by the transmitter node 102 and requested multicast frames corresponding to all retransmission requests may be sent to the receiver nodes 104-1-n. In such embodiments, a retransmitted frame may be dropped by any receiver node that did not request the retransmitted frame or by any receiver node that does not support the multicast retransmission mechanism. When received by the receiver node that requested the retransmitted frame, the missing or lost frame may be properly ordered relative to other received frames.

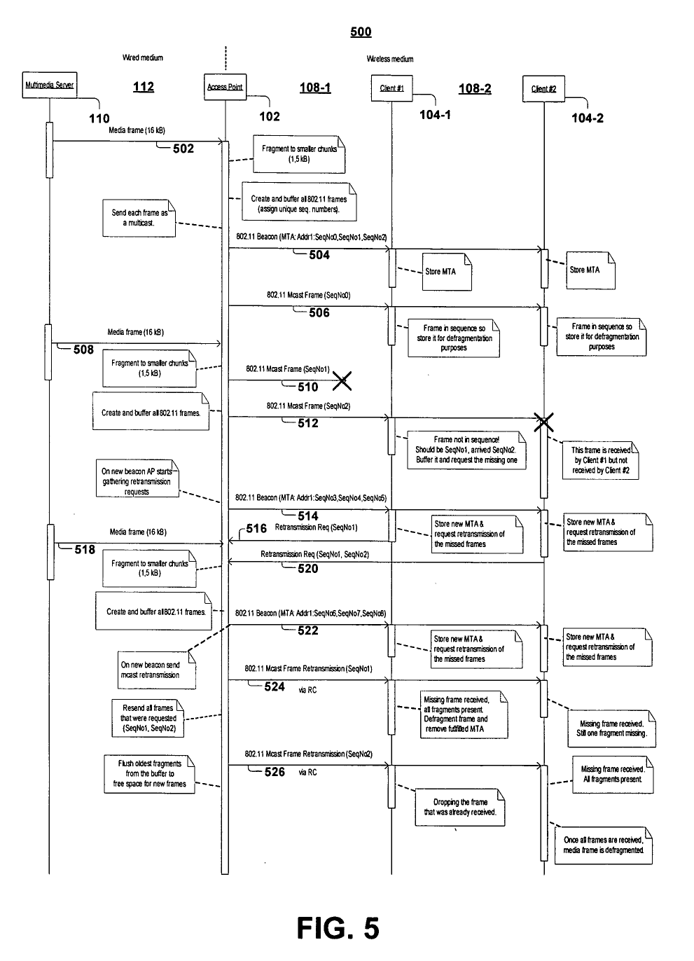

FIG. 5 illustrates one embodiment of a communication flow 500 for retransmission of media content carried by multicast frames. In various embodiments, the communication flow 500 may be performed by various systems, nodes, and/or modules and may be implemented as hardware, software, and/or any combination thereof, as desired for a given set of design parameters or performance constraints. For example, the communication flow 500 may be implemented by a logic device (e.g., transmitter node, receiver node) and/or logic (e.g., RMA logic) comprising instructions, data, and/or code to be executed by a logic device. For purposes of illustration, and not limitation, the communication flow 500 is described with reference to FIG. 1 in the context of a WLAN multicast communication environment.

In the embodiment of FIG. 5, a media source node 110 implemented as a multimedia server sends broadcast traffic comprising a media frame (e.g., 16 kB media frame) 502 to a transmitter node 102 implemented as an AP. As shown, the media frame 502 may be received over a wired communication medium 112, such as a wired Ethernet and/or P2P connection.

The transmitter node 102 fragments the media frame 502 into smaller chunks (e.g., 1.5 kB) in accordance with the 802.11 standard. The transmitter node 102 creates and buffers all multicast frames (e.g., 802.11 frames) and assigns a unique sequence number to each multicast frame.

The transmitter node 102 puts a MTA information element into a beacon 504. As shown, the MTA contains destination addresses (e.g., Addr1), sequence numbers (e.g., SeqNo0, SeqNo1, SeqNo2) of the buffered frames for each address, and a copy of the MTA sent in most recent beacon. After sending the beacon 504, the transmitter node 102 starts a buffer validity timer set, by default, to the value of two beacon periods. Once the timer expires, the buffer in the transmitter node 102 is flushed.

As shown, the receiver node 104-1 and the receiver node 104-2 receive the beacon 504, store the MTA from the beacon 504, and start multicast buffering. The receiver node 104-1 (e.g., Client #1) and the receiver node 104-2 (e.g., Client #2) may be implemented by wireless STAs. The receiver node 104-1 may communicate over a wireless communication link 108-1, and the receiver node 104-2 may communication over a wireless communication link 108-2. The wireless communication link 108-1 and the wireless communication link 108-2 each may comprise a main multicast channel and a multicast retransmission channel in accordance with the described embodiments.

The transmitter node 102 sends a multicast frame 506 with the sequence number SeqNo0 over a main multicast channel as a regular multicast stream. The multicast frame 506 may be sent during a DTIM period after sending DTIM beacon 504. As shown, both the receiver node 104-1 and the receiver node 104-2 receive the multicast frame 506 in sequence and store the multicast frame 506 for defragmentation purposes.

The media source node 110 sends a media frame 508 to the transmitter node 102. The transmitter node 102 fragments the media frame 508 into smaller chunks (e.g., 1.5 kB). The transmitter node 102 sends a multicast frame 510 with the sequence number SeqNo1 over the main multicast channel as a regular multicast stream. As shown, the receiver node 104-1 and the receiver node 104-2 do not receive the multicast frame 510 with the sequence number SeqNo1.

For the media frame 508, the transmitter node 102 creates and buffers all multicast frames (e.g., 802.11 frames) and assigns a unique sequence number to each multicast frame. The transmitter node 102 sends a multicast frame 512 with the sequence number SeqNo2 over the main multicast channel. As shown, the receiver node 104-1 receives the multicast frame 512, but not in sequence. The receiver node 104-1 buffers the multicast frame 512 and requests retransmission of the missing multicast frame 510 with the sequence number SeqNo1. The receiver node 104-2 does not receive the multicast frame 512.

The transmitter node 102 puts a MTA information element into a beacon 514. As shown, the MTA contains destination addresses (e.g., Addr1), sequence numbers (e.g., SeqNo3, SeqNo4, SeqNo5) of the buffered frames for each address, and a copy of the MTA sent in most recent beacon. After sending the beacon 514, the transmitter node 102 begins to gather retransmission requests. As shown, the receiver node 104-1 and the receiver node 104-2 receive the beacon 514, store the MTA from the beacon 514, and request retransmission of the missing frames.

The receiver node 104-1 sends a retransmission request 516 to the transmitter node 102 requesting retransmission of the missing multicast frame 510 with the sequence number SeqNo1. The media source node 110 sends a media frame 518 to the transmitter node 102. The receiver node 104-2 sends a retransmission request 520 to the transmitter node 102 requesting retransmission of the missing multicast frame 510 with the sequence number SeqNo1 and the missing multicast frame 512 with the sequence number SeqNo2.

The transmitter node 102 fragments the media frame 518 into smaller chunks (e.g., 1.5 kB), creates and buffers all multicast frames (e.g., 802.11 frames), and assigns a unique sequence number to each multicast frame. The transmitter node 102 puts a MTA information element into a beacon 522. As shown, the MTA contains destination addresses (e.g., Addr1), sequence numbers (e.g., SeqNo6, SeqNo7, SeqNo8) of the buffered frames for each address, and a copy of the MTA sent in most recent beacon. The receiver node 104-1 and the receiver node 104-2 receive the beacon 504, receive the beacon 522, store the MTA from the beacon 522, and request retransmission of missing frames.

The transmitter node 102 retransmits all requested multicast frames to the receiver node 104-1 and the receiver node 104-2. As shown, the transmitter node 102 sends the requested multicast frame 524 with the sequence number SeqNo1 over the multicast retransmission channel to the receiver node 104-1 and to the receiver node 104-2. Upon receiving the requested multicast frame 524, the receiver node 104-1 determines that all fragments are present. The receiver node 104-1 defragments the frame and removes the fulfilled MTA. Upon receiving the requested multicast frame 524, the receiver node 104-2 notes that a missing frame is received, but that one fragment is still missing.

The transmitter node 102 sends the requested multicast frame 526 with the sequence number SeqNo2 over the multicast retransmission channel to the receiver node 104-1 and to the receiver node 104-2. As shown, the receiver node 104-1 drops the multicast frame 526 with the sequence number SeqNo2 since the multicast frame 512 with the SeqNo2 previously was received. Upon receiving the requested multicast frame 526, the receiver node 104-2 determines that all fragments are present. The receiver node 104-2 defragments the frame and removes the fulfilled MTA.

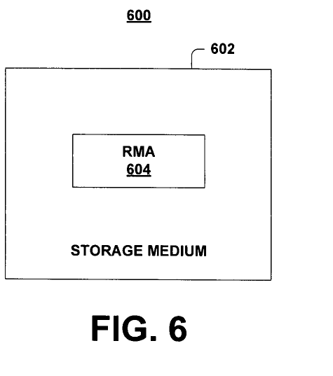

FIG. 6 illustrates one embodiment of an article of manufacture 600. As shown, the article 600 may comprise a storage medium 602 to store RMA logic 604 for performing various operations associated with retransmission of media content carried by multicast frames. In various embodiments, the article 600 may be implemented by various systems, nodes, and/or modules.

The article 600 and/or machine-readable storage medium 602 may include one or more types of computer-readable storage media capable of storing data, including volatile memory or, non-volatile memory, removable or non-removable memory, erasable or non-erasable memory, writeable or re-writeable memory, and so forth. Examples of a machine-readable storage medium may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other type of computer-readable storage media suitable for storing information. Moreover, any media involved with downloading or transferring a computer program from a remote computer to a requesting computer carried by data signals embodied in a carrier wave or other propagation medium through a communication link (e.g., a modem, radio or network connection) is considered computer-readable storage media.

The article 600 and/or machine-readable medium 602 may store RMA logic 604 comprising instructions, data, and/or code that, if executed by a machine, may cause the machine to perform a method and/or operations in accordance with the described embodiments. Such a machine may include, for example, any suitable processing platform, computing platform, computing device, processing device, computing system, processing system, computer, processor, or the like, and may be implemented using any suitable combination of hardware and/or software.

The RMA logic 604 may comprise, or be implemented as, software, a software module, an application, a program, a subroutine, instructions, an instruction set, computing code, words, values, symbols or combination thereof. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It is also worthy to note that any reference to “one embodiment” or “an embodiment” means that a particular feature, structure, or characteristic described in connection with the embodiment is included in at least one embodiment. Thus, appearances of the phrases “in one embodiment” or “in an embodiment” in various places throughout the specification are not necessarily all referring to the same embodiment. Furthermore, the particular features, structures or characteristics may be combined in any suitable manner in one or more embodiments.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus comprising:
a device to establish a main multicast channel and a multicast retransmission channel over a common wireless communication link, the device to communicate media content as one or more multicast frames over the main multicast channel and to communicate one or more requested multicast frames over the multicast retransmission channel in response to a retransmission request identifying one or more missing multicast frames lost during communication over the main multicast channel.

2. The apparatus of claim 1, the device to receive media content as one or more media frames and to fragment the media content into a sequence of multicast frames for multicast transmission, each multicast frame denoted by an identifier that allows explicit identification of each multicast frame.

3. The apparatus of claim 1, the device to transmit a multicast traffic announcement prior to transmitting one or more multicast frames, the multicast traffic announcement identifying one or more multicast frames to be transmitted over the main multicast channel.

4. The apparatus of claim 1, the device to buffer retransmission requests received from multiple stations and to retransmit requested multicast frames to each of the multiple stations over corresponding multicast retransmission channels.

5. The apparatus of claim 4, wherein a retransmitted multicast frame is dropped by any station that did not request retransmission.

6. The apparatus of claim 1, the device to receive a multicast traffic announcement prior to receiving one or more multicast frames, the multicast traffic announcement identifying one or more multicast frames to be received over the main multicast channel.

7. The apparatus of claim 6, the device to detect missing multicast frames by comparing multicast frames received over the main multicast channel against multicast frames identified in the multicast traffic announcement.

8. The apparatus of claim 6, the device to ignore the multicast traffic announcements if not understood.

9. The apparatus of claim 1, the device to receive one or more requested multicast frames over the multicast retransmission channel and to properly order requested multicast frames received relative to multicast frames received over the main multicast channel.

10. The apparatus of claim 1, the multicast retransmission channel implemented at a media access control (MAC) layer within the device.

11. The apparatus of claim 1, the device comprising at least one of an access point and a wireless station.

12. The apparatus of claim 1, the device comprising a reliable multicast agent (RMA) to manage communication of requested multicast frames over the multicast retransmission channel.

13. A system comprising:
a device to establish a main multicast channel and a multicast retransmission channel over a common wireless communication link, the device to communicate media content as one or more multicast frames over the main multicast channel and to communicate one or more requested multicast frames over the multicast retransmission channel in response to a retransmission request identifying one or more missing multicast frames lost during communication over the main multicast channel; and
an antenna coupled to the device to support communication over the wireless communication link.

14. The system of claim 13, the device to receive media content as one or more media frames and to fragment the media content into a sequence of multicast frames for multicast transmission, each multicast frame denoted by an identifier that allows explicit identification of each multicast frame.

15. The system of claim 13, the device to transmit a multicast traffic announcement prior to transmitting one or more multicast frames, the multicast traffic announcement identifying one or more multicast frames to be transmitted over the main multicast channel.

16. The system of claim 13, the device to buffer retransmission requests received from multiple stations and to retransmit requested multicast frames to each of the multiple stations over corresponding multicast retransmission channels.

17. The system of claim 16, wherein a retransmitted multicast frame is dropped by any station that did not request retransmission.

18. The system of claim 13, the device to receive a multicast traffic announcement prior to receiving one or more multicast frames, the multicast traffic announcement identifying one or more multicast frames to be received over the main multicast channel.

19. The system claim 18, the device to detect missing multicast frames by comparing multicast frames received over the main multicast channel against multicast frames identified in the multicast traffic announcement.

20. The system of claim 18, the device to ignore the multicast traffic announcement if not understood.

21. The system of claim 13, the device to receive one or more requested multicast frames over the multicast retransmission channel and to properly order requested multicast frames received relative to multicast frames received over the main multicast channel.

22. The system claim 13, the multicast retransmission channel implemented at a media access control (MAC) layer within the device.

23. A method comprising:
establishing a main multicast channel and a multicast retransmission channel over a common wireless communication link;
communicating one or more requested multicast frames over the multicast retransmission channel in response to a retransmission request identifying one or more missing multicast frames lost during communication over the main multicast channel.

24. The method of claim 23, further comprising communicating media content as one or more multicast frames over the main multicast channel.

25. The method of claim 23, further comprising communicating one or more retransmission requests.

26. An article comprising a machine-readable storage medium containing instructions that if executed enable a system to:
establish a main multicast channel and a multicast retransmission channel over a common wireless communication link;
communicate one or more requested multicast frames over the multicast retransmission channel in response to a retransmission request identifying one or more missing multicast frames lost during communication over the main multicast channel.

27. The article of claim 26, further comprising instructions that if executed enable a system to communicate media content as one or more multicast frames over the main multicast channel.

28. The article of claim 26, further comprising instructions that if executed enable a system to communicate one or more retransmission requests.
